(19) United States
(12) Patent Application Publication
(10) Pub. No.: US 2007/0014047 A1
(43) Pub. Date: Jan. 18, 2007

(54) Recording/reproduction head and recording/reproduction device

(76) Inventors: Yasuo Cho, Miyagi (JP); Atsushi Onoe, Saitama (JP)

Correspondence Address: NIXON & VANDERHYE, PC, 901 NORTH GLEBE ROAD, 11TH FLOOR, ARLINGTON, VA, 22203, US

(21) Appl. No.: 10/555,239

(22) PCT Filed: Apr. 27, 2004
(86) PCT No.: PCT/JP04/06045

§ 371 Date: Dec. 12, 2005

(30) Foreign Application Priority Data
May 1, 2003 (JP) 2003-126319

(51) Int. Cl. G11B 5/23

(52) U.S. Cl. 360/119

(57) ABSTRACT

A phase-change recording/reproduction head includes: a probe consisting of a recording/reproduction electrode, an insulation layer arranged on the tip portion of the recording/reproduction electrode, and a resistor arranged on the insulation layer; and a return electrode arranged around the probe. During recording, voltage corresponding to the recording data is applied to the resistor so that the phase change recording medium is changed from a crystalline state to an amorphous state. During reproduction, FM-modulated frequency of an oscillator oscillating according to the capacity corresponding to the dielectric constant of the crystalline state and the amorphous state is demodulated, thereby reproducing data with a high SN ratio.

### TECHNICAL FIELD

The present invention relates to a recording/reproducing head for recording data into a phase change recording medium which uses a phase change material or reproducing the data recorded in the phase change recording medium, as well as a recording apparatus, a reproducing apparatus, and a recording/reproducing apparatus.

### BACKGROUND ART

As high-density and large-capacity recording/reproducing apparatuses of randomly accessible type, there are known an optical disk apparatus and an HDD (Hard Disk Drive) apparatus. Moreover, a recording/reproducing technique using SNDM (Scanning Nonlinear Dielectric Microscopy) for nanoscale analysis of a dielectric recording medium has been recently proposed by the inventors of the present invention.

Optical recording uses an optical pickup with a laser as a light source. Data is recorded by forming pits in a layer or layers of an organic die or phase change material formed on a disk. The data is reproduced by using the difference in the reflectance of the layer or layers depending on the presence or absence of pits. Alternatively, there is a technique to record and reproduce data by using a magneto optical effect. However, the optical pickup is larger than the magnetic head of the HDD. Therefore, the optical pickup is inappropriate for high-speed reading. Also, the size of the pit is restricted by the diffraction limit of light, so that the recording density is limited to 50 G bit/inch².

Moreover, in the longitudinal recording of magnetic recording as represented by the HDD, an MR head using GMR (Giant Magnetic Resistance) has been recently realized. Furthermore, by using perpendicular magnetic recording, the recording density is expected to be larger than that of the optical disk. However, the recording density is limited to 1 T bit/inch² because of thermal fluctuation of magnetic recording information and the presence of a Bloch wall in a portion in which a code is reversed, even if patterned media are used to overcome these phenomena.

The SNDM can gauge the positive and negative directions of a ferroelectric domain by measuring the non-linear dielectric constant of a ferroelectric recording medium. In the SNDM, it is possible to increase the resolution related to the measurement to sub-nanometer, by using an electrically conductive cantilever (or probe) having a small probe on its tip, which is used for AFM (Atomic Force Microscopy) or the like.

### DISCLOSURE OF THE INVENTION

In the recording/reproducing apparatus to which the SNDM technique, which is currently under development, is applied, data is recorded by applying an electric field stronger than a coercive electric field to the ferroelectric recording medium from the probe, to thereby form a polarization domain having a predetermined polarization direction in the dielectric recording medium. On the other hand, the data is reproduced by detecting a polarization state from a change in oscillation frequency of an oscillation signal which is oscillated at a resonance frequency formed from an inductor and a capacitance of the dielectric recording medium under the probe.

In the recording/reproduction using such a ferroelectric material as the recording medium, there are objects to improve the SN ratio of a reproduction signal, and eventually to improve an error rate or improve a recording/reproducing speed; however, it is not easy to realize the objects.

On the other hand, it is known that the recording medium using the phase change material generally has high recording resolution. However, in the conventional recording/reproducing apparatus using the phase change recording medium, as described above, since the recording density is limited because of the diffraction limit of a laser, there is a limit to improve the recording density.

In order to solve the above problems, it is therefore an object of the present invention to provide a recording/reproducing head for recording data into a phase change recording medium by using a probe memory method or reproducing the data recorded in the phase change recording medium by using the SNDM method, which can increase the recording density and which can realize the high quality recording/reproduction of the data, as well as a recording apparatus, a reproducing apparatus, and a recording/reproducing apparatus to which the recording/reproduction head is applied.

The present invention will be discussed hereinafter.

The above object of the present invention can be achieved by a first recording/reproducing head for recording data into a phase change recording medium or for reproducing data recorded in the phase change medium, the recording/reproducing head provided with: a probe having: (i) a reproducing electrode for detecting the data, which is made of a conductive member and which has a substantially spherical protrusive tip having a predetermined radius; (ii) an insulation layer covering the tip of the reproducing electrode; and (iii) a resistive member which is located on the insulation layer and which generates heat in recording the data; and a return electrode, which is located around the probe, for returning a high-frequency component of an electric field applied to the probe.

The first recording/reproducing head of the present invention has the probe, which abuts on or is adjacent to the phase change material, for recording or reproducing the data. The probe is provided, in the center portion, with: the reproducing electrode which has a substantially spherical tip; the insulation layer covering the tip of the reproducing electrode; and the resistive member located on the insulation layer with it insulated from the reproducing electrode. Around the probe constructed in this manner, there is provided the return electrode for returning the high-frequency component of an electric field applied to the probe. Moreover, in order to apply a voltage to the resistive member, lead lines may be provided in the both end portions of the diameter of the resistive member.

Upon the data recording, the recording is performed by applying a pulse voltage corresponding to the data to the resistive member of the probe, and by changing the phase change material from a crystalline state to an amorphous state by the generated heat of the resistive member. Moreover, it is possible to return to the crystalline state from the amorphous state by changing a heating condition for the medium. By this, it is possible to delete the recorded data. On the other hand, upon the data reproduction, the reproduction is performed by applying an electric field to the phase change recording medium, and by gauging or distinguishing the difference in the dielectric constant of the crystalline state and the amorphous state of the phase change material. The return electrode is an electrode for returning a high frequency electric field which oscillates with a capacitance corresponding to the dielectric constant of the crystalline state or the amorphous state.

The above object of the present invention can be also achieved by a second recording/reproducing head for recording data into a phase change recording medium or for reproducing data recorded in the phase change medium, the recording/reproducing head provided with: a probe having: a supporting member which is made of an insulating member and which has a substantially spherical protrusive tip having a predetermined radius; and a resistive member which is located on the tip of the supporting member and which generates heat in recording the data; and a return electrode, which is located around the probe, for returning a high-frequency component of an electric field applied to the probe.

The second recording/reproducing head of the present invention has the probe, which abuts on or is adjacent to the phase change material, for recording or reproducing the data. The probe is provided, in the center portion, with: the supporting member which is made of an insulating member and which has a substantially spherical tip; the insulation layer covering the tip of the reproducing electrode; and the resistive member covering the tip of the supporting member. Around the probe constructed in this manner, there is provided the return electrode for returning the high-frequency component of an electric field applied to the probe.

Upon the data recording, the recording is performed by applying a pulse voltage corresponding to the data to the resistive member of the probe, and by changing the phase change material from a crystalline state to an amorphous state by the generated heat of the resistive member. It is preferable to apply the voltage from the both end portions of the diameter of the resistive member. On the other hand, upon the data reproduction, the resistive member is separated from a circuit for heating, and the resistive member is incorporated into a circuit which is constructed such that an electric field is applied to the phase change recording medium, to thereby apply an electric field to the phase change material. The data reproduction is performed by gauging or distinguishing the difference in the dielectric constant of the crystalline state and the amorphous state of the phase change material. The return electrode is an electrode for returning a high frequency electric field which oscillates with the capacitance corresponding to the dielectric constant of the crystalline state or the amorphous state.

In one aspect of the first or second recording/reproducing head of the present invention, a heat quantity generated by the resistive member may change a phase change material of the phase change recording medium from a crystalline state to an amorphous state.

According to this aspect, it is possible to change the state of the phase change material which is initially set to the crystalline state, from the crystalline state to the amorphous state, in accordance with the data to be recorded, by generating heat on the resistive member in accordance with the data. By this, it is possible to record the data into the phase change material.

In another aspect of the first or second recording/reproducing head of the present invention, the recording/reproducing head may be a head for recording or reproducing the data in the phase change recording medium on the basis of nonlinear dielectric microscopy.

According to this aspect, it is possible to record the data into the phase change material of the phase change recording medium at high density and reproduce it with a high SN ratio.

Incidentally, the nonlinear dielectric microscopy is introduced in detail in “Oyo Butsuri (Applied Physics)”, the Japan Society of Applied Physics, vol. 67, No. 3, p 327-331 (1998), which is written by Yasuo Cho, one of the present inventors.

The above object of the present invention can be also achieved by a recording apparatus for recording data into a phase change material of a phase recording medium, the recording apparatus provided with: the above-mentioned first or second recording/reproducing head; a heating device for generating heat in accordance with the data by applying an electric current to the resistive member of the recording/reproducing head; and a recording signal generating device for generating a recording signal which corresponds to the data and which is inputted to the heating device.

According to the recording apparatus of the present invention, a voltage corresponding to the data to be recorded is applied to the resistive member of the above-mentioned first or second recording/reproducing head, and by the heat generated at that time, the phase change material of the phase change recording medium is changed, in accordance with the data, from the crystalline state to the amorphous state. By this, the data is recorded.

The above object of the present invention can be also achieved by a first reproducing apparatus for reproducing data recorded in a phase change material of a phase recording medium, the reproducing apparatus provided with: the above-mentioned first recording/reproducing head; an electric field applying device for applying an electric field to the phase change recording medium; an oscillating device in which an oscillation frequency changes depending on a difference in a dielectric constant of a crystalline state or an amorphous state of the phase change recording medium; a demodulating device for demodulating an oscillation signal caused by the oscillating device; and a data reproducing device for reproducing the data from the signal demodulated by the demodulating device.

On the first reproducing apparatus of the present invention, an electric field is applied to the phase change recording medium. For example, an alternating electric field may be generated by applying an alternate current (AC) signal to the phase change recording medium, or an electric field may be generated by applying a direct current (DC) bias voltage to the phase change recording medium. In the oscillation signal of the oscillating device, the oscillation frequency thereof varies depending on the difference of the dielectric constant of the crystalline state or the amorphous state of the phase change material. The data is reproduced on the basis of the oscillation frequency of the oscillation signal. The oscillation frequency of the oscillation signal is determined from a resonance frequency, which is determined from the capacitance under the probe, which depends on the difference of the dielectric constant of the crystalline state or the amorphous state of the phase change material, and the inductance of an external inductor. Namely, the capacitance varies depending on the difference of the dielectric constant of the crystalline state or the amorphous state, and by this capacity change, the oscillation frequency is FM-modulated. This FM modulated signal is demodulated, and the data is reproduced from the demodulated signal.

The above object of the present invention can be also achieved by a second reproducing apparatus for reproducing data recorded in a phase change material of a phase recording medium, the reproducing apparatus provided with: the above-mentioned second recording/reproducing head; an electric field applying device for applying an electric field to the phase change recording medium; an oscillating device in which an oscillation frequency changes depending on a difference in a dielectric constant of a crystalline state or an amorphous state of the phase change recording medium; a demodulating device for demodulating an oscillation signal caused by the oscillating device; and a data reproducing device for reproducing the data from the signal demodulated by the demodulating device.

On the second reproducing apparatus of the present invention, an electric field is applied to the phase change recording medium. For example, an alternating electric field may be generated by applying an AC signal to the phase change recording medium, or an electric field may be generated by applying a DC bias voltage to the phase change recording medium. In the oscillation signal of the oscillating device, the oscillation frequency thereof varies depending on the difference of the dielectric constant of the crystalline state or the amorphous state of the phase change material. The data is reproduced on the basis of the oscillation frequency of the oscillation signal. The oscillation frequency of the oscillation signal is determined from a resonance frequency, which is determined from the capacitance under the probe, which depends on the difference of the dielectric constant of the crystalline state or the amorphous state of the phase change material, and the inductance of an external inductor. Namely, the capacitance varies depending on the difference of the dielectric constant of the crystalline state or the amorphous state, and by this capacity change, the oscillation frequency is FM-modulated. This FM modulated signal is demodulated, and the data is reproduced from the demodulated signal. Incidentally, the resistive member of the above-mentioned second recording/reproducing head is used as the heating device upon the data recording and is used as a device for detecting the data in the present invention, so that the resistive member is connected to the oscillator side.

In one aspect of the first or second reproducing apparatus of the present invention, the data reproducing device may reproduce the data by synchronous detection.

According to this aspect, if an AC signal is applied to the phase change recording medium by the electric field applying device to generate an alternating electric field in the phase recording material, the oscillation signal which is FM-modulated on the basis of the capacitance corresponding to the dielectric constant of the crystalline state or the amorphous state of the phase change material is FM-demodulated, and the data is reproduced from the demodulated signal by the synchronous detection. In the synchronous detection, the AC signal, which is applied to the phase change recording medium by the electric applying device, is used as a reference signal.

In another aspect of the first or second reproducing apparatus of the present invention, the data reproducing device may reproduce the data by phase detection.

According to this aspect, if an AC signal is applied to the phase change recording medium by the electric field applying device to generate an alternating electric field in the phase recording material, the oscillation signal which is FM-modulated on the basis of the capacitance corresponding to the dielectric constant of the crystalline state or the amorphous state of the phase change material is FM-demodulated, and the data is reproduced by the phase detection for comparing the phase of the demodulated signal with the phase of the AC signal, which is applied to the phase change recording medium by the electric applying device.

The above object of the present invention can be also achieved by a first recording/reproducing apparatus, which uses the above-mentioned first recording/reproducing head, for recording or reproducing data in a phase change material of a phase recording medium, the recording/reproducing apparatus provided with: (i) as a recording apparatus, a heating device for generating heat in accordance with the data by applying an electric current to the resistive member of the probe; and a recording signal generating device for generating a recording signal which corresponds to the data and which is inputted to the heating device, and (ii) as a reproducing apparatus, an electric field applying device for applying an electric field to the phase change recording medium; an oscillating device in which an oscillation frequency changes depending on a difference in a dielectric constant of a crystalline state or an amorphous state of the phase change recording medium; a demodulating device for demodulating an oscillation signal caused by the oscillating device; and a data reproducing device for reproducing the data from the signal demodulated by the demodulating device.

According to the first recording/reproducing apparatus of the present invention, it is possible to record the data into the phase change material of the phase change recording medium and reproduce it, by using the above-mentioned first recording/reproducing head. Upon the recording, a voltage corresponding to the data to be recorded is applied to the resistive member of the recording/reproducing head, and by the heat generated at that time, the phase change material of the phase change recording medium is changed, in accordance with the data, from the crystalline state to the amorphous state. That is how to record the data.

On the other hand, upon the reproduction, an electric field is applied to the phase change recording medium. For example, an alternating electric field may be generated by applying an AC signal to the phase change recording medium, or an electric field may be generated by applying a DC bias voltage to the phase change recording medium. In the oscillation signal of the oscillating device, the oscillation frequency thereof varies depending on the difference of the dielectric constant of the crystalline state or the amorphous state of the phase change material. Thus, the data is reproduced on the basis of the oscillation frequency of the oscillation signal. The oscillation frequency of the oscillation signal is determined from a resonance frequency, which is determined from the capacitance under the probe, which depends on the difference of the dielectric constant of the crystalline state or the amorphous state of the phase change material, and the inductance of an external inductor. Namely, the capacitance varies depending on the difference of the dielectric constant of the crystalline state or the amorphous state, and by this capacity change, the oscillation frequency is FM-modulated. This FM modulated signal is demodulated, and the data is reproduced from the demodulated signal.

Incidentally, in the first recording/reproducing head used in the present invention, the resistive member and the reproducing electrode are independently provided, so that the recording/reproduction operation can be performed simultaneously. Thus, it is possible to monitor the recording state of the data by reproducing the data which is being recorded.

The above object of the present invention can be also achieved by a second recording/reproducing apparatus, which uses the above-mentioned second recording/reproducing head, for recording or reproducing data in a phase change material of a phase recording medium, the recording/reproducing apparatus provided with: (i) as a recording apparatus, a heating device for generating heat in accordance with the data by applying an electric current to the resistive member of the probe; and a recording signal generating device for generating a recording signal which corresponds to the data and which is inputted to the heating device; (ii) as a reproducing apparatus, an electric field applying device for applying an electric field to the phase change recording medium; an oscillating device in which an oscillation frequency changes depending on a difference in a dielectric constant of a crystalline state or an amorphous state of the phase change recording medium; a demodulating device for demodulating an oscillation signal caused by the oscillating device; and a data reproducing device for reproducing the data from the signal demodulated by the demodulating device.

According to the second recording/reproducing apparatus of the present invention, it is possible to record the data into the phase change material of the phase change recording medium and reproduce it, by using the above-mentioned second recording/reproducing head. Upon the recording, a voltage corresponding to the data to be recorded is applied to the resistive member of the recording/reproducing head, and by the heat generated at that time, the phase change material of the phase change recording medium is changed, in accordance with the data, from the crystalline state to the amorphous state. By this, the data is recorded.

On the other hand, upon the reproduction, an electric field is applied to the phase change recording medium. For example, an alternating electric field may be generated by applying an AC signal to the phase change recording medium, or an electric field may be generated by applying a DC bias voltage to the phase change recording medium. In the oscillation signal of the oscillating device, the oscillation frequency thereof varies depending on the difference of the dielectric constant of the crystalline state or the amorphous state of the phase change material. Thus, the data is reproduced on the basis of the oscillation frequency of the oscillation signal. The oscillation frequency of the oscillation signal is determined from a resonance frequency, which is determined from the capacitance under the probe, which depends on the difference of the dielectric constant of the crystalline state or the amorphous state of the phase change material, and the inductance of an external inductor. Namely, the capacitance varies depending on the difference of the dielectric constant of the crystalline state or the amorphous state, and by this capacity change, the oscillation frequency is FM-modulated. This FM modulated signal is demodulated, and the data is reproduced from the demodulated signal.

Incidentally, in the second recording/reproducing head used in the present invention, the resistive member is used as the heating device upon the recording, and it is used as a device for detecting the data upon the reproduction. Thus, the recording signal from the recording signal generating device is applied to the resistive member upon the recording, while the electric field from the electric field applying device is applied to the phase change recording medium upon the reproduction. The change between a circuit for applying the recording signal upon the recording and a circuit for applying the electric field upon the recording is performed by the changing device changes.

In one aspect of the first or second recording/reproducing apparatus of the present invention, the data reproducing device may reproduce the data by synchronous detection.

According to this aspect, if an AC signal is applied to the phase change recording medium by the electric field applying device to generate an alternating electric field in the phase recording material, the oscillation signal which is FM-modulated on the basis of the capacitance corresponding to the dielectric constant of the crystalline state or the amorphous state of the phase change material is FM-demodulated, and the data is reproduced from the demodulated signal by the synchronous detection. In the synchronous detection, the AC signal, which is applied to the phase change recording medium by the electric applying device, is used as a reference signal.

In another aspect of the second recording/reproducing apparatus of the present invention, the data reproducing device reproduces the data by phase detection.

According to this aspect, if an AC signal is applied to the phase change recording medium by the electric field applying device to generate an alternating electric field in the phase recording material, the oscillation signal which is FM-modulated on the basis of the capacitance corresponding to the dielectric constant of the crystalline state or the amorphous state of the phase change material is FM-demodulated, and the data is reproduced by the phase detection for comparing the phase of the demodulated signal with the phase of the AC signal, which is applied to the phase change recording medium by the electric applying device.

Incidentally, in the recording/reproducing head, the recording apparatus, the reproducing apparatus, and the recording/reproducing apparatus, which are discussed above, as the probe for applying an electric field, a pin shape or needle-shape, cantilever-shape probe and the like can be used. Electrodes having such a shape are collectively referred to as “the probe”, as occasion demands.

Moreover, as the phase change material, a phase change material, such as GeInSbTe system, which is a eutectic material, is used. Other phase change materials may be also used.

As described above, according to the recording/reproducing head, the recording apparatus, the reproducing apparatus, or the recording/reproducing apparatus of the present invention, the domains or areas of the phase change material are heated by using the extremely small probe, to thereby change the crystalline state and the amorphous state of the phase change material and to record the data. Thus, it is possible to greatly improve the recording density of the data. Therefore, it is possible to overcome the barrier of the recording density, which is known as a limit in a conventional optical disk system, and to realize the super high-density recording of the data.

Furthermore, the heating portion of the probe is extremely small and the heat capacity thereof is small, so that a practically sufficient recording response speed can be ensured.

In addition, according to the recording/reproducing head, the recording apparatus, the reproducing apparatus, or the recording/reproducing apparatus of the present invention, attention is focused on the fact that the linear dielectric constant or nonlinear dielectric constant of the phase change material varies depending on the difference in the crystalline state and the amorphous state of the phase change material, and it is constructed such that the difference in the dielectric constant is detected to reproduce the data. Thus, it is possible to reproduce the data that is recorded at super high density, clearly and in high quality. In particular, the SNDM technique can be applied, so that it is possible to realize the same recording/reproduction performance or greater performance than that of the recording/reproduction technique using a ferroelectric substance as the recording medium.

These effects and other advantages of the present invention become more apparent from the following embodiments and examples.

### BRIEF DESCRIPTION OF DRAWINGS

FIG. 1 is a schematic diagram showing a first embodiment of a recording/reproducing head associated with the present invention.

FIG. 2 is a schematic diagram showing a second embodiment of the recording/reproducing head associated with the present invention.

FIG. 3 is a schematic diagram to explain the recording/reproduction of information with respect to a phase change material.

FIG. 4 is a schematic diagram showing the structure of an embodiment of a recording apparatus associated with the present invention.

FIG. 5 is a schematic diagram showing the structure of an embodiment of a reproducing apparatus associated with the present invention.

FIG. 6 is a schematic diagram showing the structure of a first embodiment of a recording/reproducing apparatus associated with the present invention.

FIG. 7 is a schematic diagram showing the structure of a second embodiment of a recording/reproducing apparatus associated with the present invention.

### BEST MODE FOR CARRYING OUT THE INVENTION

### First Embodiment of Recording/Reproducing Head

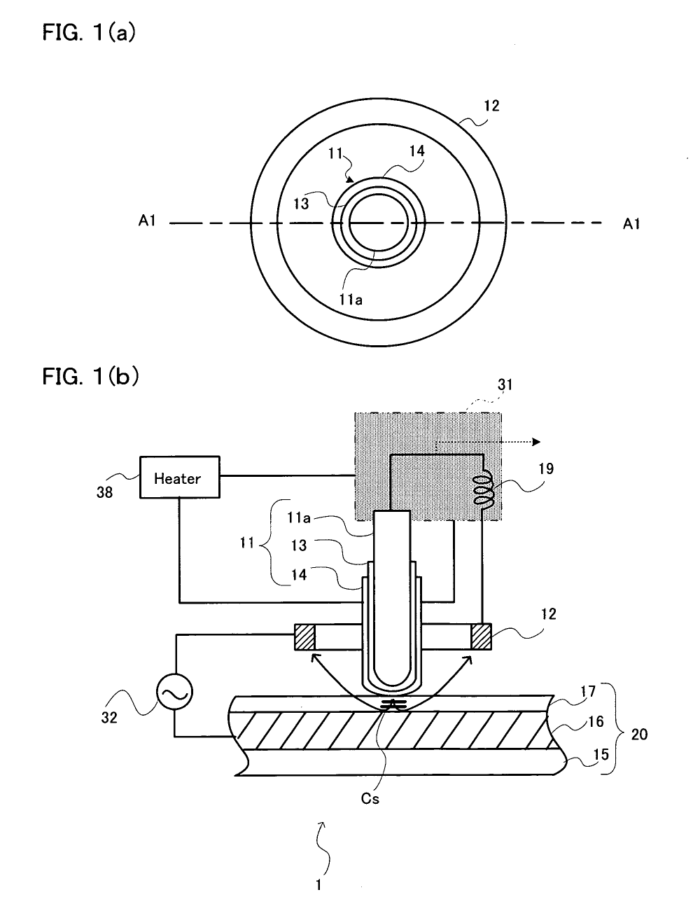

The first embodiment of the recording/reproducing head of the present invention will be discussed, with reference to FIG. 1(a) and FIG. 1(b). FIG. 1(a) is a plan view of the first embodiment, and FIG. 1(b) is an A1-A1 cross sectional view of FIG. 1(a).

As shown in FIG. 1, a recording/reproducing head 1 is provided with: a probe 11, which is made of a recording/reproducing electrode 11a, an insulation layer 13 located on the tip of the recording/reproducing electrode 11a, and a resistive member 14 located on the insulation layer 13; and a return electrode 12 located around the probe 11.

The probe 11 is provided with: (i) the recording/reproducing electrode 11a which is made of a conductive member, and whose tip, which is a portion facing to a phase change material 16, is substantially spherical and has a predetermined radius; (ii) the insulation layer 13 which is located on the tip of the recording/reproducing electrode 11a and which is made of an insulating member; and (iii) the resistive member 14 which is located on the insulation layer 13 and which has a predetermined specific resistance. The recording/reproducing electrode 11a is an electrode in nonlinear dielectric microscopy. The radius of the tip of the probe 11, facing the phase change material 16 of a phase change recording medium 20, is extremely small, on the order of 10 nm. Moreover, as the probe 11, there are probes in a needle-shape, a cantilever-shape and the like. On the other hand, the phase change material 16 is set to be crystalline on the whole recording surface, as an initial state. As the phase change material 16, a phase change material, such as GeInSbTe system, which is a eutectic material, is used.

The return electrode 12 is an electrode for returning a high frequency electric field applied to the phase change recording medium 20 from the probe 11, and it is located to surround the probe 11. Incidentally, if the high frequency electric field returns to the return electrode 12 without resistance, its shape and location can be set arbitrarily.

The recording, performed by the recording/reproducing head 1, is performed by applying a voltage corresponding to the record data to the resistive member 14 of the probe 11, and changing the surface of the phase change material 16 from a crystalline state to an amorphous state by the generated heat.

On the other hand, the reproduction, performed by the recording/reproducing head 1, is performed by applying an alternate current (AC) signal to the phase change material 16 of a phase change recording medium 20, and detecting a capacitance Cs which is determined from the crystalline state or the amorphous state of the phase change material 16. Namely, there is a difference in a nonlinear dielectric constant between the crystalline state and the amorphous state of the phase change material 16, and in accordance with the difference in the nonlinear dielectric constant, the capacitance Cs changes. The data is reproduced by detecting the change in the capacitance Cs. According to the scanning nonlinear dielectric microscopy (SNDM) method which is applied to the present invention, it is possible to detect the difference in the nonlinear dielectric constant between the crystalline state and the amorphous state at a high SN ratio.

Incidentally, as a device for applying a voltage corresponding to record data to the resistive member 14, there is a heater 38, for example. As a device for generating an AC signal to be applied, there is an AC signal generator 32. Moreover, there is an oscillator 31 which oscillates at a resonance frequency that is determined from an inductance L of an inductor 19 and the capacitance Cs, in order to detect the capacitance Cs. The oscillation frequency of the oscillator 31 is FM-modulated by the change in the capacitance Cs corresponding to the dielectric constant of the crystalline state or the amorphous state of the phase change material 16. By FM-demodulating the oscillation signal, the difference in the crystalline state and the amorphous state, i.e., the record data is detected.

Moreover, a point (portion) at which a voltage is applied to the resistive member 14 is set to a point (portion) where the tip of the probe 11 substantially generates heat. For example, a preferable point (portion) is the both ends of the diameter of the resistive member 14, close to the tip. On the other hand, as described above, the recording/reproducing head 1 has the resistive member 14 for recording and the recording/reproducing electrode 11a for reproduction, so that it is possible to simultaneously perform the recording and the reproduction. Incidentally, as shown in FIG. 1, the phase change material 16 of the phase change recording medium 20 is located on a substrate 15, and an insulating thin film 17 is formed on the surface of the phase change material 16.

According to the recording/reproducing head 1 having such a structure, the SNDM technique is used to record data into the phase material or to reproduce data recorded in the phase material. Thus, it is possible to greatly improve the recording density and realize the high quality recording and reproduction of data. Namely, the original SNDM is known as a device for electrically detecting the polarization state of a ferroelectric material. However, in the embodiment, attention is focused on the fact that the linear dielectric constant or nonlinear dielectric constant of the phase change material varies depending on the difference in the crystalline state and the amorphous state of the phase change material, and a new reproduction principle is adopted which is the difference in the dielectric constant of the phase change material is detected by the SNDM. By this, it is possible to clearly gauge data recorded in the phase change recording medium, by virtue of the difference in the crystalline state and the amorphous state of the phase change material, to thereby reproduce data in high quality.

Moreover, in the embodiment, a small probe which is equal to or smaller than what is used for the cantilever of the AFM is used to heat the phase change material, so that it is possible to heat only an extremely small area (domain) of the phase change material. By this, it is possible to realize super high-density recording, which cannot be realized in a conventional optical disk system.

Furthermore, the heating portion of the probe in the embodiment is extremely small and the heat capacity thereof is small, so that a recording response speed is high and a practically sufficient recording response speed can be ensured.

### Second Embodiment of Recording/Reproducing Head

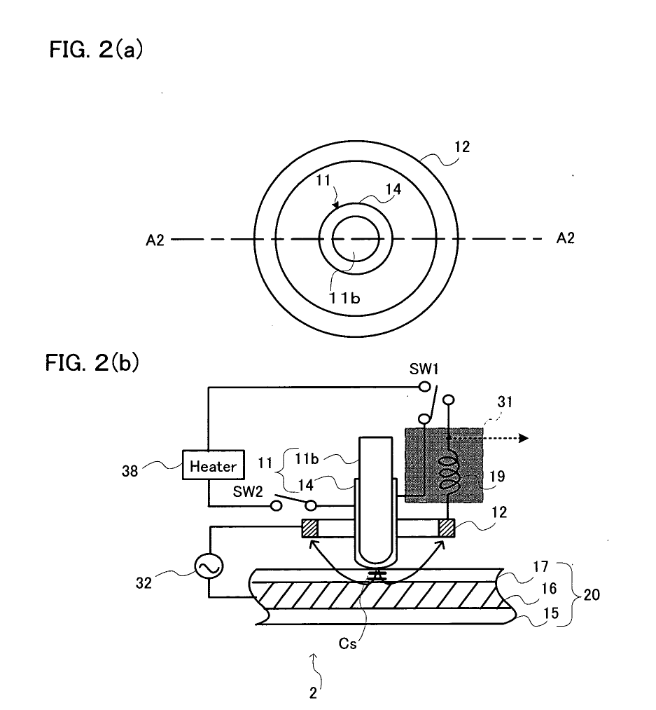

The second embodiment of the recording/reproducing head of the present invention will be discussed, with reference to FIG. 2. FIG. 2(a) is a plan view of the first embodiment, and FIG. 2(b) is an A2-A2 cross sectional view of FIG. 2(a).

As shown in FIG. 2, a recording/reproducing head 2 is provided with: a probe 11, which is made of a supporting member 11b and a resistive member 14 located on the tip of the supporting member 11b; and a return electrode 12 located around the probe 11.

The probe 11 is provided with: the supporting member 11b whose tip, which is a portion facing to a phase change material 16, is substantially spherical and has a predetermined radius; and the resistive member 14 which is located on the supporting member 11b and which has predetermined specific resistance. The radius of the tip of the probe 11, facing the phase change material 16 of a phase change recording medium 20, is extremely small, on the order of 10 nm. As the probe 11, there are probes in a needle-shape, a cantilever-shape and the like.

The return electrode 12 is an electrode for returning a high frequency electric field applied to the phase change recording medium 20 from the probe 11, and it is located to surround the probe 11. Incidentally, if the high frequency electric field returns to the return electrode 12 without resistance, its shape and location can be set arbitrarily.

The recording, performed by the recording/reproducing head 2, is performed by applying a voltage corresponding to record data to the resistive member 14 of the probe 11, and by changing the surface of the phase change material 16 from a crystalline state to an amorphous state by the generated heat. Incidentally, the phase change material 16 is set to be crystalline on the whole recording surface, as an initial state.

On the other hand, the reproduction, performed by the recording/reproducing head 2, is performed by applying an AC signal to the phase change material 16 of a phase change recording medium 20, and detecting a capacitance Cs which is determined from the crystalline state or the amorphous state of the phase change material 16. Namely, there is a great difference in a nonlinear dielectric constant between the crystalline state and the amorphous state of the phase change material 16, and in accordance with the difference in the nonlinear dielectric constant, the capacitance Cs changes. The data is reproduced on the basis of the change in the capacitance Cs.

Incidentally, as a device for applying a voltage the corresponding to record data to the resistive member 14, there is a heater 38, for example. As a device for generating an AC signal to be applied, there is an AC signal generator 32. Moreover, there is an oscillator 31 which oscillates at a resonance frequency that is determined from an inductance L of an inductor 19 and the capacitance Cs, in order to detect the capacitance Cs. The oscillation frequency of the oscillator 31 is FM-modulated by the change in the capacitance Cs corresponding to the dielectric constant of the crystalline state or the amorphous state of the phase change material 16. By FM-demodulating the oscillation signal, a difference in the crystalline state and the amorphous state, i.e., the record data is detected. Incidentally, a resistive component caused by the resistive member 14 is appended to the oscillation circuit, to thereby reduce the level of the oscillation signal.

As described above, the resistive member 14 of the recording/reproducing head 2 is used as a heater electrode for recording and an electrode for reproduction. Thus, it is necessary to change a signal to be applied to the resistive member 14 upon recording and upon reproduction. The change is performed on a SW1 and a SW2. Namely, Switching of the circuits is performed as follows. The SW1 and the SW2 are set to the heater 38 side upon recording, while the SW1 is set to the oscillator side and the SW2 is left open upon reproduction.

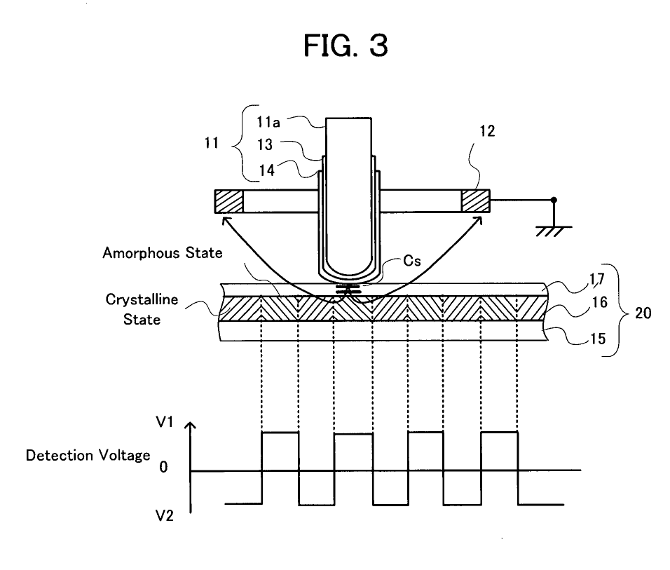

Next, with reference to FIG. 3, the recording/reproduction of the data will be discussed.

At first, the recording will be discussed. It is assumed that the phase change material 16 of the phase change recording medium 20 is all crystalline in the beginning. In this state, the probe 11 is located on the site to be recorded, and a voltage is applied to the resistive member 14. The resistive member 14 generates heat by the applied voltage, to thereby change the phase change material 16 on the site, from the crystalline state to the amorphous state. By changing the voltage to be applied to the resistive member 14 in accordance with data, it is possible to change the heat of the resistive member 14 in accordance with the data. Then, while the recording/reproducing head 2 is displaced and scanned relatively with respect to the phase change recording medium 20, the heating operation corresponding to the data is performed. As a result, the crystalline state or the amorphous state of the phase change material 16 changes in accordance with the data, and the arrangement of the crystalline state and the amorphous state is formed in the phase change material 16 in accordance with the data. In this manner, the recording of the data into the phase change material is realized. The recording operation is performed by using the probe 11 with a tip radius on the order of 10 nm, so that it is possible to greatly improve the recording density of the data.

Next, with respect to the reproduction, an AC signal is applied to the phase change material 16 of the phase change recording medium 20. There is provided the inductor 19 with the inductance of L between the recording/reproducing electrode 11a and the return electrode 12. The inductor 19 and the capacitance Cs corresponding to the dielectric constant of the crystalline state or the amorphous state under the probe 11 constitute a resonance circuit. The inductance L of the inductor 19 is determined so that the resonance frequency, f=½√LCs, is about 1 GHz, for example.

The oscillation signal based on the resonance frequency is FM-modulated by the capacitance Cs corresponding to the dielectric constant of the crystalline state or the amorphous state. By FM-demodulating the FM-modulated signal, the difference in the crystalline state and the amorphous state is distinguished, and the data is thus reproduced. Using the SNDM allows the discrimination of the difference in the crystalline state and the amorphous state with a high SN ratio, which realizes the high-quality reproduction of data.

### Embodiment of Recording Apparatus

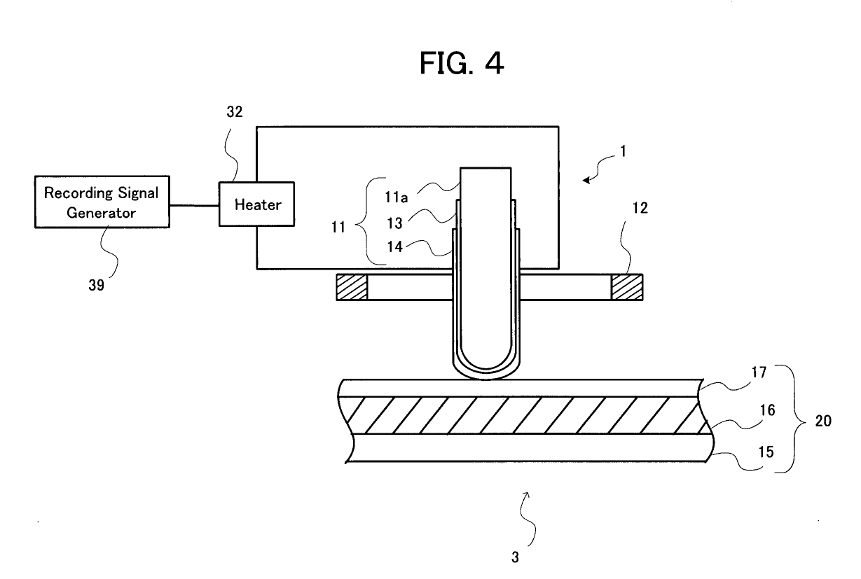

An embodiment of the recording apparatus associated with the present invention will be discussed with reference to FIG. 4. As shown in FIG. 4, a recording apparatus 3 has the recording/reproducing head 1 which is provided with a probe 11, which is made of a recording/reproducing electrode 11a, an insulation layer 13 located on the tip of the recording/reproducing electrode 11a, and a resistive member 14 located on the insulation layer 13; and a return electrode 12 located around the probe 11. The recording apparatus 3 also has a heater 32 for applying a voltage to a resistive member 14 and a recording signal generator 39 for generating data to be recorded. A signal generated by the recording signal generator 39 corresponding to the data is inputted to the heater 32.

At first, a phase change material 16 is set to be crystalline on the whole recording surface, as an initial state. With respect to a phase change recording medium 20 in this state, the heater 32 heats the resistive member 14 on the basis of the signal from the recording signal generator 39, and changes the state of phase change material 16 of the phase change recording medium 20 into the amorphous state by the heat radiated by the resistive member 14. The probe 11 is displaced and scanned, while touching or facing the phase change recording medium 20 with a small space. In the phase change material 16, the amorphous areas are formed as the data by the heat radiated by the resistive member 14, in the crystalline surface.

The recording signal generator 39 generates the data to be recorded. The data may be converted in a predetermined recording format, or the data may include data in which a process related to accompanying control information and an error correction, a process of data compression or the like is performed.

Incidentally, the recording/reproducing head 2 may be used in place of the recording/reproducing head 1. In this case, a SW1 and a SW2 are connected to the heater 38 side, and a voltage corresponding to the data to be recorded is applied to the resistive member 14 to heat.

### Embodiment of Reproducing Apparatus

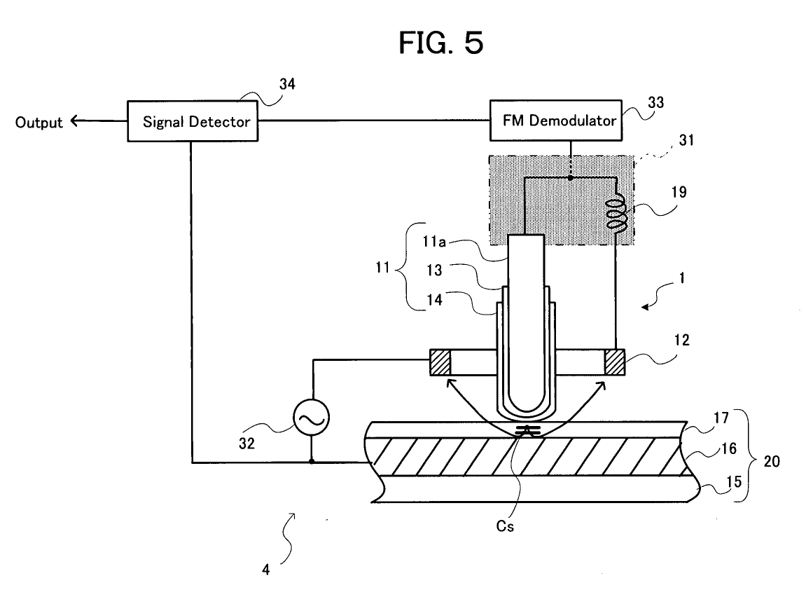

An embodiment of a dielectric reproducing apparatus associated with the present invention will be discussed with reference to FIG. 5.

As shown in FIG. 5, a reproducing apparatus 4 has the recording/reproducing head 1 which is provided with: a probe 11, which is made of a recording/reproducing electrode 11a, an insulation layer 13 located on the tip of the recording/reproducing electrode 11a, and a resistive member 14 located on the insulation layer 13; and the return electrode 12 located around the probe 11. Moreover, the reproducing apparatus 4 is also provided with: an inductor 19, which is located between the recording/reproducing electrode 11a of the probe 11 and the return electrode 12; an oscillator 31 which oscillates at a resonance frequency that is determined from an inductance L of the inductor 19 and a capacitance Cs corresponding to the dielectric constant of the crystalline state or the amorphous state of a phase change material 16 under the probe 11; an AC signal generator 32 for generating an AC signal which is applied to the phase change material 16; a frequency modulation (FM) demodulator 33 for demodulating an oscillation signal modulated by the capacitance Cs corresponding to the dielectric constant of the crystalline state or the amorphous state; a signal detector 34 for reproducing data from the demodulated signal; and the like.

The probe 11 touches or faces the phase change material 16 of a phase change recording medium 20 with a small space. Corresponding to the radius of the tip of the probe 11, crystalline or amorphous areas are formed in the phase change recording medium 20. The crystalline or amorphous areas correspond to data. Upon reproduction, the capacitance Cs, which corresponds to the dielectric constant of the crystalline state or the amorphous state of the phase change material 16 at the tip of the probe 11, participates in a resonance circuit made with the inductor 19, so that the oscillation frequency comes to depend on the capacitance Cs. By demodulating an oscillation signal which is FM-modulated on the basis of this capacitance Cs, a detection voltage shown in FIG. 3 is outputted, and the recorded data is reproduced.

The AC signal generator 32 generates an AC signal which is applied to the phase change material 16 of the phase change recording medium 20. Incidentally, the AC signal is also used as a reference signal when the data is reproduced from the FM-demodulated signal.

The inductor 19 is located between the recording/reproducing electrode 11a and the return electrode 12, and may be formed from a microstripline, for example. The inductance L of the inductor 19 and the capacitance Cs constitute the resonance circuit. The inductance L of the inductor 19 is determined so that the resonance frequency, f=½π√LCs, is about 1 GHz, for example.

For the phase change recording medium 20, a phase change material, such as GeInSbTe system, which is a eutectic material, or the like is used. Moreover, as the shape of phase change recording medium 20, there are a disk shape, a card shape, and the like, for example. The relative displacement to the probe 11 is performed by the rotation of the medium or by the linear displacement of either the probe 11 or the medium.

The oscillator 31 oscillates at a frequency determined from the inductance L and the capacitance Cs. The oscillation frequency thereof changes in accordance with the change in the capacitance Cs, so that it is FM-modulated in accordance with the change in the capacitance Cs which is determined from the dielectric constant of the crystalline state or the amorphous state corresponding to the recorded data. By demodulating this FM modulation, it is possible to read the recorded data.

The FM demodulator 33 demodulates the oscillation frequency of the oscillator 31 modulated by the capacitance Cs, and reconstructs the waveform of the data recorded in accordance with the crystalline state or the amorphous state at the site where the probe 11 traces. This is performed by FM-demodulating the frequency which is modulated in accordance with the recorded data.

The signal detector 34 reproduces the recorded data on the basis of the signal demodulated on the FM demodulator 33 and the applied AC signal from the AC signal generator 32. For the reproduction of the signal, it is possible to use a synchronous detection method, a phase detection method, or the like. For example, a lock-in amplifier or the like is preferably used as a device for the synchronous detection.

As explained above, according to the reproducing apparatus 4, it is 10 possible to detect the difference in the crystalline state and the amorphous state corresponding to the data formed on the phase change material 16 of the phase change recording medium 20, to thereby reproduce the data with a good SN ratio.

Incidentally, the recording/reproducing head 2 may be used in place of the recording/reproducing head 1. In this case, a SW1 is connected to the oscillator 31 side, and a SW2 is left open.

### First Embodiment of Recording/Reproducing Apparatus

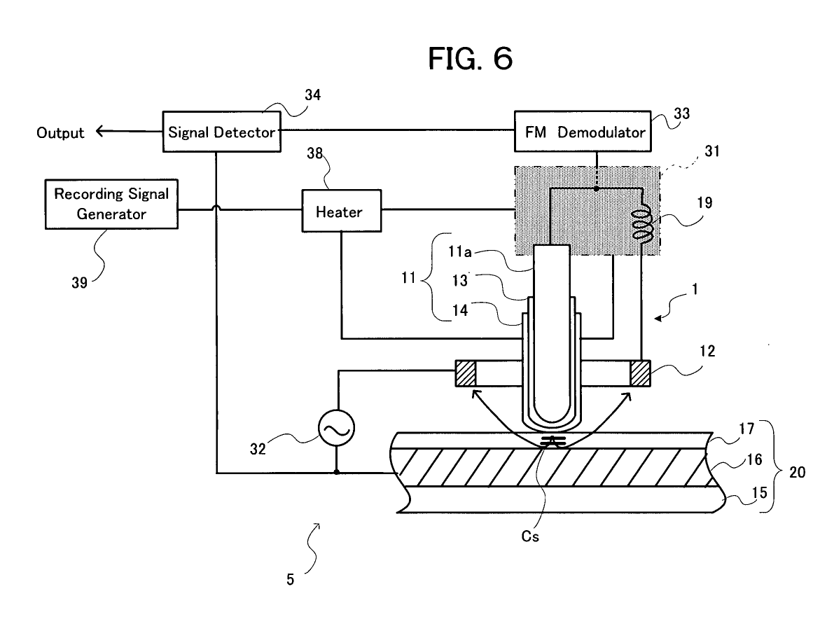

The first embodiment of the recording/reproducing apparatus in the present invention will be discussed with reference to FIG. 6. Incidentally, the detailed operation and effect of each constitutional element of a recording/reproducing apparatus 5 are the same as those explained in the recording apparatus 3 and the reproducing apparatus 4, which are referred to, as occasion demands.

As shown in FIG. 6, the recording/reproducing apparatus 5 has a recording/reproducing head 1 which is provided with: a probe 11, which is made of a recording/reproducing electrode 11a, an insulation layer 13 located on the tip of the recording/reproducing electrode 11a, and a resistive member 14 located on the insulation layer 13; and the return electrode 12 located around the probe 11. Moreover, the recording/reproducing apparatus 5 is also provided with: a heater 38 for applying a voltage to a resistive member 14 to heat; and a recording signal generator 39 for generating a signal to be inputted to the heater 38, as a recording system. Moreover, the recording/reproducing apparatus 5 is also provided with: an inductor 19, which is located between the recording/reproducing electrode 11a of the probe 11 and the return electrode 12; an oscillator 31 which oscillates at a resonance frequency that is determined from an inductance L of the inductor 19 and a capacitance Cs corresponding to the dielectric constant of the crystalline state or the amorphous state of a phase change material 16 under the probe 11; an AC signal generator 32 for generating an AC signal which is applied to the phase change material 16; a FM demodulator 33 for demodulating an oscillation signal modulated by the capacitance Cs corresponding to the dielectric constant of the crystalline state or the amorphous state; a signal detector 34 for reproducing data from the demodulated signal; and the like, as a reproduction system.

In the recording operation, a signal corresponding to data to be recorded is generated by the recording signal generator 39, and is inputted to the heater 38. A voltage is applied to the resistive member 14 of the probe 11 from the heater 38, and the resistive member 14 is heated and generates heat. This heat changes the phase change material 16 of a phase change recording medium 20 from the crystalline state to the amorphous state, to thereby record the data.

In the reproduction operation, the data recorded in association with the crystalline state or the amorphous state of the phase change material 16 is reproduced by gauging the difference in the crystalline state and the amorphous state. An AC signal generated by the AC signal generator 32 is applied to the phase change material 16 of the phase change recording medium 20. The inductance L of the inductor 19 and the capacitance Cs corresponding to the dielectric constant of the crystalline state or the amorphous state constitute a resonance circuit. The oscillator 31 oscillates at the frequency of the resonance circuit. The oscillation signal is FM-modulated by the capacitance Cs and FM-demodulated by the FM demodulator 33. The recorded data is reproduced on the signal detector 34 from the demodulated signal, on the basis of the AC signal from the AC signal generator 32.

As explained above, the recording/reproducing apparatus 6 in the first embodiment has the recording system and the reproduction system as individual functions, from the using recording/reproducing head 1. The recording/reproducing apparatus 6 can perform the reproduction operation while performing the recording operation; namely, it can confirm the recording state of the recorded data while performing the recording.

### Second Embodiment of Recording/Reproducing Apparatus

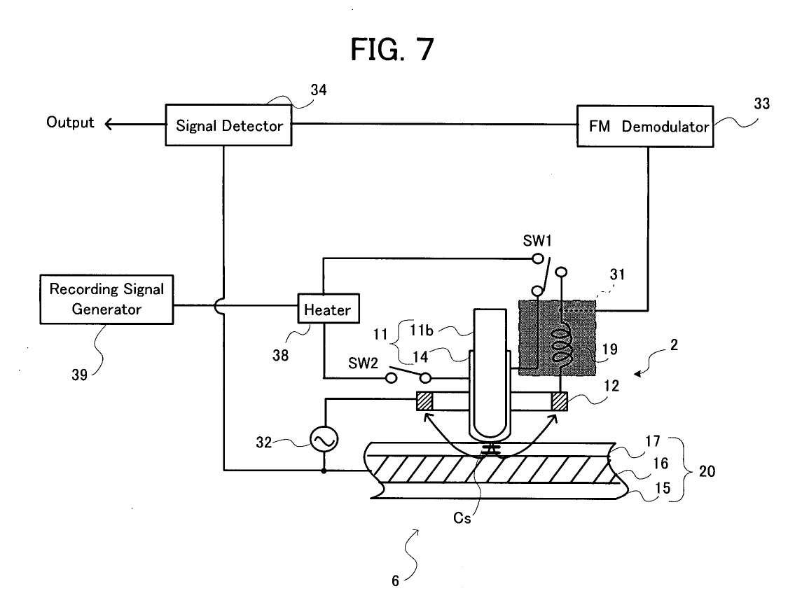

The second embodiment of the recording/reproducing apparatus in the present invention will be discussed with reference to FIG. 7. Incidentally, the detailed operation and effect of each constitutional element of a recording/reproducing apparatus 6 are the same as those explained in the recording apparatus 3 and the reproducing apparatus 4, which are referred to, as occasion demands.

As shown in FIG. 7, the recording/reproducing apparatus 6 has a recording/reproducing head 2 which is provided with: a probe 11, which is made of a supporting member 11b and a resistive member 14 located on the tip of the supporting member 11b; and a return electrode 12 located around the probe 11. Moreover, the recording/reproducing apparatus 6 is also provided with: a heater 38 for applying a voltage to a resistive member 14 to heat; and a recording signal generator 39 for generating a signal to be inputted to the heater 38, as a recording system. Moreover, the recording/reproducing apparatus 6 is also provided with: an inductor 19, which is located between the resistive member 14 of the probe 11 and the return electrode 12; an oscillator 31 which oscillates at a resonance frequency that is determined from an inductance L of the inductor 19 and a capacitance Cs corresponding to the dielectric constant of the crystalline state or the amorphous state of a phase change material 16 under the probe 11; an AC signal generator 32 for generating an AC signal which is applied to the phase change material 16; a FM demodulator 33 for demodulating an oscillation signal modulated by the capacitance Cs corresponding to the dielectric constant of the crystalline state or the amorphous state; a signal detector 34 for reproducing data from the demodulated signal; and the like, as a reproduction system.

In the recording operation, a SW1 and a SW2 are both connected to the heater 38 side, and a signal generated by the recording signal generator 39 corresponding to data to be recorded is inputted to the heater 38. A voltage is applied to the resistive member 14 of the probe 11 from the heater 38, and the resistive member 14 is heated and generates heat. This heat changes the phase change material 16 of a phase change recording medium 20 from the crystalline state to the amorphous state, to thereby record the data.

In the reproduction operation, the SW1 is connected to the oscillator 31 side, and the SW2 is left open so as to connect the resistive member 14 with the inductor 19 and the oscillator 31. Therefore, an AC signal generated by the AC signal generator 32 is applied to the phase change material 16 of the phase change recording medium 20.

The recorded data is reproduced by gauging the difference in the crystalline state and the amorphous state of the phase change material 16. An AC signal generated by the AC signal generator 32 is applied to the phase change material 16 of the phase change recording medium 20. The inductance L of the inductor 19 and the capacitance Cs corresponding to the dielectric constant of the crystalline state or the amorphous state constitute a resonance circuit. The oscillator 31 oscillates at the frequency of the resonance circuit. The oscillation signal is FM-modulated by the capacitance Cs and FM-demodulated by the FM demodulator 33. The recorded data is reproduced on the signal detector 34 from the demodulated signal, on the basis of the AC signal from the AC signal generator 32.

The present invention is not limited to the above-described embodiments, and various changes may be made, if desired, without departing from the essence or spirit of the invention which can be read from the claims and the entire specification. A recording/reproducing head, a recording apparatus, a reproducing apparatus, and a recording/reproducing apparatus, all of which involve such changes, are also intended to be within the technical scope of the present invention.

### INDUSTRIAL APPLICABILITY

A recording/reproducing head, a recording apparatus, a reproducing apparatus, and a recording/reproducing apparatus in the present invention can be applied to a recording/reproducing head in which data is recorded or reproduced in a phase change recording medium by using scanning nonlinear dielectric microscopy (SNDM), as a technique capable of realizing high-density, large-capacity recording, as well as a recording apparatus, a reproducing apparatus, and a recording/reproducing apparatus, which use the recording/reproducing head.

1. A recording/reproducing head for recording data into a phase change recording medium or for reproducing data recorded in the phase change medium,
said recording/reproducing head comprising:
a probe having: (i) a reproducing electrode, which is made of a conductive member, and which has a substantially spherical protrusive tip having a predetermined radius for detecting the data; (ii) an insulation layer covering the substantially spherical protrusive tip; and (iii) a resistive member which is located on a portion of the insulation layer which covers the substantially spherical protrusive tip and which generates heat in recording the data; and
a return electrode, which is located around said probe, for returning a high-frequency component of an electric field applied to said probe.

2. A recording/reproducing head for recording data into a phase change recording medium or for reproducing data recorded in the phase change medium,
said recording/reproducing head comprising:
a probe having: a supporting member, which is made of an insulating member, and which has a substantially spherical protrusive tip having a predetermined radius for detecting the data; and a resistive member which covers the substantially spherical protrusive tip and which generates heat in recording the data; and
a return electrode, which is located around said probe, for returning a high-frequency component of an electric field applied to said probe.

3. The recording/reproducing head according to claim 1, wherein a heat quantity generated by the resistive member changes a phase change material of the phase change recording medium from a crystalline state to an amorphous state.

4. The recording/reproducing head according to claim 2, wherein a heat quantity generated by the resistive member changes a phase change material of the phase change recording medium from a crystalline state to an amorphous state.

5. The recording/reproducing head according to claim 1, wherein the recording/reproducing head is a head for recording or reproducing the data in the phase change recording medium on the basis of nonlinear dielectric microscopy.

6. The recording/reproducing head according to claim 2, wherein the recording/reproducing head is a head for recording or reproducing the data in the phase change recording medium on the basis of nonlinear dielectric microscopy.

7. A recording apparatus for recording data into a phase change material of a phase recording medium,
said recording apparatus comprising:
the recording/reproducing head according to claim 1;
a heating device for generating heat in accordance with the data by applying an electric current to the resistive member of the recording/reproducing head; and
a recording signal generating device for generating a recording signal which corresponds to the data and which is inputted to the heating device.

8. A recording apparatus for recording data into a phase change material of a phase recording medium,
said recording apparatus comprising:
the recording/reproducing head according to claim 2;
a heating device for generating heat in accordance with the data by applying an electric current to the resistive member of the recording/reproducing head; and
a recording signal generating device for generating a recording signal which corresponds to the data and which is inputted to the heating device.

9. A reproducing apparatus for reproducing data recorded in a phase change material of a phase recording medium,
said reproducing apparatus comprising:
the recording/reproducing head according to claim 1;
an electric field applying device for applying an electric field to the phase change recording medium;
an oscillating device in which an oscillation frequency changes depending on a difference in a dielectric constant of a crystalline state or an amorphous state of the phase change recording medium;
a demodulating device for demodulating an oscillation signal caused by said oscillating device; and
a data reproducing device for reproducing the data from the signal demodulated by said demodulating device.

10. A reproducing apparatus for reproducing data recorded in a phase change material of a phase recording medium,
said reproducing apparatus comprising:
the recording/reproducing head according to claim 2;
an electric field applying device for applying an electric field to the phase change recording medium;
an oscillating device in which an oscillation frequency changes depending on a difference in a dielectric constant of a crystalline state or an amorphous state of the phase change recording medium;
a demodulating device for demodulating an oscillation signal caused by said oscillating device; and
a data reproducing device for reproducing the data from the signal demodulated by said demodulating device.

11. The reproducing apparatus according to claim 9, wherein said data reproducing device reproduces the data by synchronous detection.

12. The reproducing apparatus according to claim 10, wherein said data reproducing device reproduces the data by synchronous detection.

13. The reproducing apparatus according to claim 9, wherein said data reproducing device reproduces the data by phase detection.

14. The reproducing apparatus according to claim 10, wherein said data reproducing device reproduces the data by phase detection.

15. A recording/reproducing apparatus, which uses the recording/reproducing head according to claim 1, for recording or reproducing data in a phase change material of a phase recording medium,
said recording/reproducing apparatus comprising:
(i) as a recording apparatus,
a heating device for generating heat in accordance with the data by applying an electric current to the resistive member of the probe; and
a recording signal generating device for generating a recording signal which corresponds to the data and which is inputted to the heating device, and
(ii) as a reproducing apparatus,
an electric field applying device for applying an electric field to the phase change recording medium;
an oscillating device in which an oscillation frequency changes depending on a difference in a dielectric constant of a crystalline state or an amorphous state of the phase change recording medium;
a demodulating device for demodulating an oscillation signal caused by said oscillating device; and
a data reproducing device for reproducing the data from the signal demodulated by said demodulating device.

16. A recording/reproducing apparatus, which uses the recording/reproducing head according to claim 2, for recording or reproducing data in a phase change material of a phase recording medium,
said recording/reproducing apparatus comprising:
(i) as a recording apparatus,
a heating device for generating heat in accordance with the data by applying an electric current to the resistive member of the probe; and
a recording signal generating device for generating a recording signal which corresponds to the data and which is inputted to the heating device;
(ii) as a reproducing apparatus,
an electric field applying device for applying an electric field to the phase change recording medium;
an oscillating device in which an oscillation frequency changes depending on a difference in a dielectric constant of a crystalline state or an amorphous state of the phase change recording medium;
a demodulating device for demodulating an oscillation signal caused by said oscillating device; and
a data reproducing device for reproducing the data from the signal demodulated by said demodulating device.

17. The recording/reproducing apparatus according to claim 15, wherein said data reproducing device reproduces the data by synchronous detection.

18. The recording/reproducing apparatus according to claim 16, wherein said data reproducing device reproduces the data by synchronous detection.

19. The recording/reproducing apparatus according to claim 15, wherein said data reproducing device reproduces the data by phase detection.

20. The recording/reproducing apparatus according to claim 16, wherein said data reproducing device reproduces the data by phase detection.

21. The recording/reproducing head according to claim 1, wherein a voltage is applied to the resistive member.

22. The recording/reproducing head according to claim 2, wherein a voltage is applied to the resistive member.
